(19) United States
(12) Patent Application Publication
(10) Pub. No.: US 2013/0041837 A1
(43) Pub. Date: Feb. 14, 2013

(54) Online Data And In-Store Data Analytical System

(71) Applicants: Kelly L. Dempski, Redwood City, CA (US); Brian M. Landry, Oakland, CA (US)

(72) Inventors: Kelly L. Dempski, Redwood City, CA (US); Brian M. Landry, Oakland, CA (US)

(73) Assignee: Accenture Global Services Limited, Dublin (IE)

(21) Appl. No.: 13/572,363

(22) Filed: Aug. 10, 2012

Related U.S. Application Data
(60) Provisional application No. 61/523,119, filed on Aug. 12, 2011.

(51) Int. Cl. G06Q 30/02

(52) U.S. Cl. 705/345; 705/1.1

(57) ABSTRACT

An online data and in-store data analytical system and method provide a customer or store sales person sales with an output to improve the customer's in-store experience. The system identifies relevant customer information from both the customer's online data and in-store activity. The online data and in-store data analytical system uses the identified customer data to generate a customer profile, which includes several customer attributes, and also generate an output to the customer, a selected store sales person, or both. The generated output can suggest potential products for the customer to consider or potential discounts, enhancing the customer's in-store sales experience. The generated output may also include product feedback information originating from a social connection of the customer, a person similar to the customer, or others.

### CROSS REFERENCE TO RELATED APPLICATIONS

This application claims the benefit of priority to the following U.S. Provisional Application Ser. No. 61/523,119, entitled “ONLINE DATA AND IN-STORE DATA ANALYTICAL SYSTEM,” filed on Aug. 12, 2011, the contents of which are hereby incorporated herein by reference in its entirety.

### BACKGROUND OF THE INVENTION

1. Technical Field

This disclosure relates to leveraging online and in-store data. In particular, this disclosure relates to analyzing a customer's online data and in-store data to provide an output to a customer and/or a store sales person.

2. Related Art

In the past decade, the meteoric rise of the Internet has allowed online commerce to grow exponentially. A customer may access a retailer's online website, allowing the customer to browse through and purchase the retailer's products. Through advances in Internet navigation technology, the retailer's online website is able to glean information about the customer based on the customer's interaction with a retailer's website. Retailer websites are capable of identifying the specific products a customer views or tracking the purchase history of the customer.

In a similar respect, customers may visit a retailer's physical “brick and mortar” store to purchase the retailer's products. A store sales person can determine data about a customer's purchase intent (i.e., why the customer visited the store or the customer's interest in a type of product/service or a brand of product/service) by directly interacting with the customer.

### SUMMARY

An online/in-store analysis system leverages the online data of a customer and the customer's in-store data to generate an output. The online/in-store analysis system receives customer online data generated by the customer's online activity and customer in-store data indicative of the customer's in-store activity. As one example, the online/in-store analysis system may receive store online history data attributable to the customer, online social media attributable to the customer, or data indicative of the walking path of the customer in the store. The online/in-store analysis system generates an output to a receiving party, such as a customer or sales person. For example, a generated output directed to a store customer may suggest potential products for the customer's consideration. The generated output directed to a store customer may also include customized product information, product feedback from the customer's social connections, or product feedback from similar individuals. The online/in-store analysis system may also provide the customer with a feedback capability, allowing the customer to solicit real-time feedback concerning a product from, as an example, a social network. To that end, the online/in-store analysis system determines a particular receiving party and generates an output based on the customer online data and customer in-store data. The system then transmits the generated output to the determined receiving party.

Other systems, methods and features will be, or will become, apparent to one with skill in the art upon examination of the following figures and detailed description. It is intended that all such additional systems, methods and features be included within this description, be within the scope of the disclosure, and be protected by the following claims.

### BRIEF DESCRIPTION OF THE DRAWINGS

The system may be better understood with reference to the following drawings and description. In the figures, like reference numerals designate corresponding parts throughout the different views.

FIG. 1 shows an example of an online/in-store system.

FIG. 2 shows a flow chart for enhancing a customer's in-store experience.

FIG. 3 shows a flow chart for generating or updating a customer profile.

FIG. 4 shows a flow chart for updating one or more customer attributes in the customer profile.

FIG. 5 shows an output analysis engine.

FIG. 6 shows a flow chart for generating an output to a customer.

FIG. 7 shows a flow chart for generating an output to a store sales person.

FIG. 8 shows an example of a customer device.

FIG. 9 shows an example of a customer output.

FIG. 10 shows an example of a customer output with respect to a purchase target other than the customer.

### DETAILED DESCRIPTION

An online/in-store analysis system is provided that integrates online data with in-store data. The online/in-store analysis system may leverage a customer's online activity and data to enhance the customer's in-store experience. The online/in-store analysis system may identify one or more types of online data. Online data includes data generated by online activity. One example of online data is customer online data generated by the customer's online activities and associated with the customer. Examples of the customer online data include online searches performed by the customer (such as searches initiated by the customer or purchases by the customer using the store's internet servers) and online postings generated by the customer (such as Facebook® posts, Twitter® tweets, etc.)

The online/in-store analysis system may also identify one or more types of in-store data. In-store data includes data generated by activity in the store. One example of customer in-store data is data generated by the customer's in-store activities and associated with the customer. Examples of the customer's in-store data include real-time data indicative of the walking path of the customer inside the store and data indicative of in-store products scanned by the customer, as discussed in more detail below. Another example of the customer's in-store data includes historical customer in-store data indicative of previous in-store activities, such as data indicative of previous in-store purchases, previous walking paths of the customer inside the store, previous products scanned by the customer, etc. The customer online data may then be used in combination with customer in-store data.

The online/in-store analysis system may generate a customer profile. The customer profile may be based on the customer online data and the customer in-store data. As discussed in more detail below, the customer profile may include one or more attributes, with the one or more attributes being based at least in part on the customer online data and/or the customer's in-store data. The online/in-store analysis system may also determine a customer's purchase intent, which may indicate why the customer visited the store, a purchase target a customer intends to purchase a product for, or the customer's interest in a type of product/service or a brand of product/service.

The online/in-store analysis system may access one or more sources of information, such as the customer profile and real-time data associated with the customer's in-store experience, in order to generate one or more outputs. For example, the online/in-store analysis system may generate one or more outputs for transmission to the customer as the customer is in the store. The one or more outputs may suggest to the customer a particular product that matches a customer's purchasing intent or offer discounts on products the customer may be interested in. Or, the one or more outputs may provide customized product information specific to the customer. The one or more outputs may additionally display, product feedback from the customer's social connections or product feedback from persons meeting a similarity criteria with respect to the customer. As another example, the online/in-store analysis system may generate one or more outputs for transmission to one or more sales people in the store, allowing the sales people to assist the customer according to the customer's purchase intent and background.

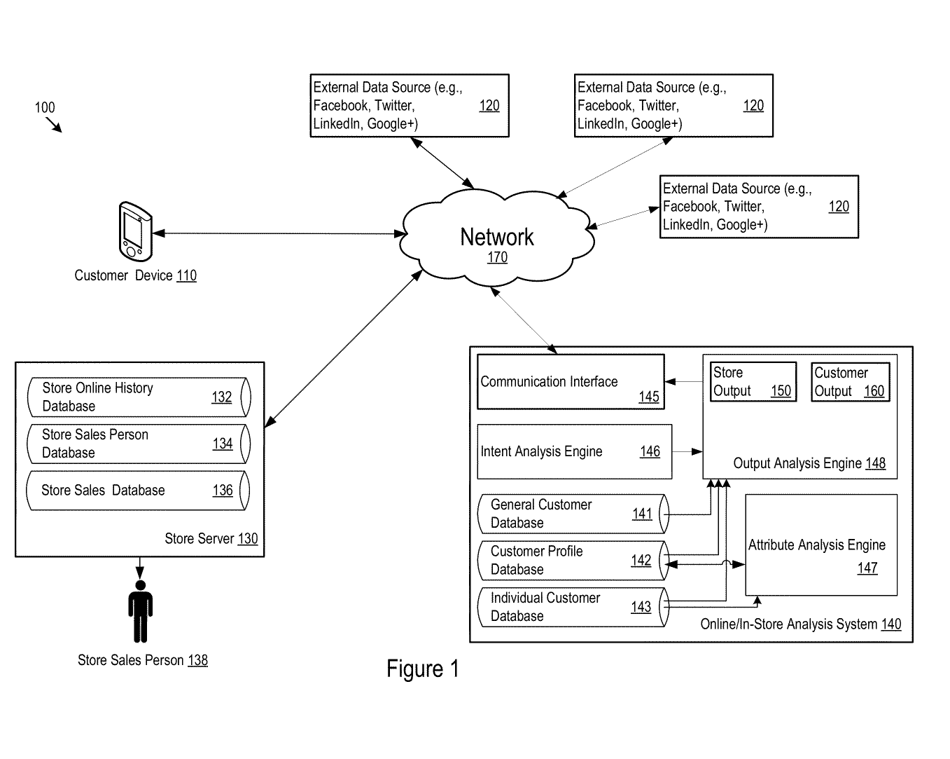

FIG. 1 shows an example of an online/in-store system 100. The online/in-store system 100 includes a customer device 110, multiple external data sources 120, a store server 130 and an online/in-store analysis system 140, each connected to a network 170. The sales analysis system 100 may also include a store sales person 138.

The customer device 110 is an electronic device that enables the customer to interact with various parts of the online/in-store system 100. In one embodiment, the customer device 110 may be a portable electronic device, such as a smartphone, an iPad®, or other type of mobile computing device with wireless communication functionality. The customer device 110 may communicate with the store server 130 and external data sources 120, as discussed below. Further, the customer device 110 may interact with the online/in-store analysis system 140, as discussed below.

The store server 130 may be a computing device serving the needs or requests of other devices (such as customer device 110). The store server 130 may include information related to products and/or services provided by the store and may provide the other devices (such as the customer device 110) with searching capabilities to search the products and/or services provided by the store. The store server 130 includes a store online history database 132, a store sales person database 134, and a store sales database 136. The store server 130 also includes a processor (not pictured) and memory (not pictured). The store sales person 138 is in communication with the store server 130, for example through an electronic device, mobile device, electronic terminal, an audio communication device (e.g., an earpiece), in-store radio, or other devices.

The online/in-store analysis system 140 includes a communication interface 145, a general customer database 141, a customer profile database 142, and an individual customer database 143. The online/in-store analysis system 140 further includes an intent analysis engine 146, an attribute analysis engine 147, and an output analysis engine 148. The intent analysis engine 146 transmits data to the output analysis engine 148. The customer profile database 142 is coupled to the attribute analysis engine 147, and the individual customer database 143 transmits data to the attribute analysis engine 147. Each of the online/in-store analysis system databases (e.g., 141-143) also transmits data to the output analysis engine 148. The output analysis engine 148 produces two outputs, a store output 150 and a customer output 160. Operation of each of these analysis engines (e.g., 146-148) is discussed below.

In operation, the online/in-store analysis system 140 may produce one or more outputs, such as a store output 150 (directed to one or more store sales people) and/or one or more customer outputs 160 (directed to the customer). To generate an output, the online/in-store analysis system 140 may utilize customer online data and/or customer in-store data. For example, the online/in-store analysis system 140 may use one or more factors, such as the customer profile, a determined customer purchase intent, general customer data and general store data. The customer profile may include one or more attributes associated with the customer, and may be based in part or entirely on customer online data. The determined customer's purchase intent may be an indicator of the customer's intent to purchase a product or service or a purchase target the customer's purchase is intended for, as determined by the intent analysis engine 146. The output analysis engine 148 may generate the customer output 160 and the store output 150.

The customer profile may indicate one or more factors affecting a customer's potential purchase activity, such as a customer's preferences in purchasing products (i.e., features the customer is interested in, price range of products, brand names, potential areas of use for the product, etc.). The online/in-store analysis system 140 may generate the customer profile based, at least in part, on the customer online data, that is, data generated online attributable to a specific customer. The customer online data may include the online store activity attributable to the customer, such as the customer's online store browsing history and/or the customer's online store purchase history. The online/in-store analysis system 140 may retrieve such customer online data from the store online history database 132 of the store server 130. The online/in-store analysis system 140 may also identify customer online data from one or more external data sources 120. As an example, external data sources may include various online social media services, such as Facebook®, Twitter®, LinkedIn® or Google+®. A customer's personal social media account may be linked to the online/in-store analysis system 140 to identify and retrieve the customer online data. The online/in-store analysis system 140 may store the retrieved customer online data in the individual customer database 143.

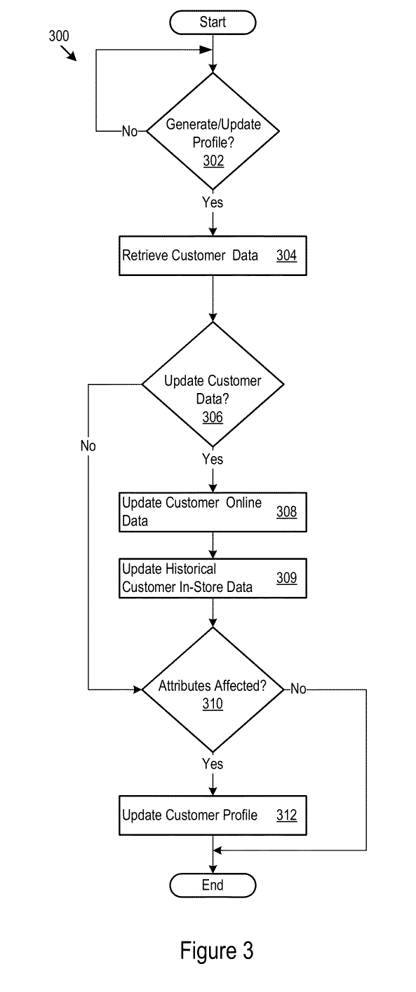

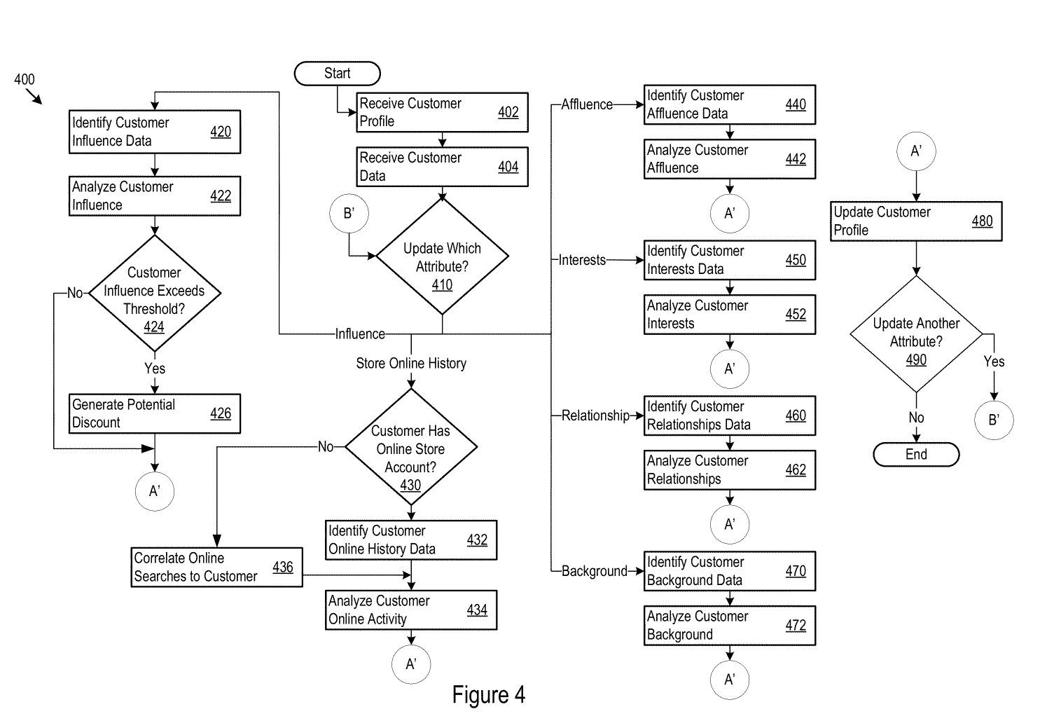

The online/in-store analysis system 140 may also generate a customer profile based, at least in part, on customer in-store data, such as historical customer in-store data. The online/in-store analysis system 140 may retrieve historical customer in-store data relevant to generating the customer profile. For example, the online/in-store analysis system 140 may retrieve the customer's in-store purchase history from the store sales database 136 of the store server 130. The process of generating a customer profile based on the customer online data and historical customer in-store data is discussed in greater detail below in FIGS. 3 and 4.

The online/in-store analysis system 140 may also gather general customer data (i.e., data not directly attributable to a specific customer). One source of general customer data may be the store server 130. The online/in-store analysis system 140 may retrieve general customer data from the store online history database 312 or the store sales database 136. The online/in-store analysis system 140 may also retrieve general customer data from the multiple external data sources 120 or by aggregating customer profile data and individual customer data stored in the system database (e.g., 142, 143). As an example of general customer data, the online/in-store analysis system 140 may retrieve and determine the educational trends for a particular geographic area or determine the percentage of a specific population segment sharing a particular interest or purchase preference. The online/data information system 140 may store this retrieved general customer data in the general customer database 141.

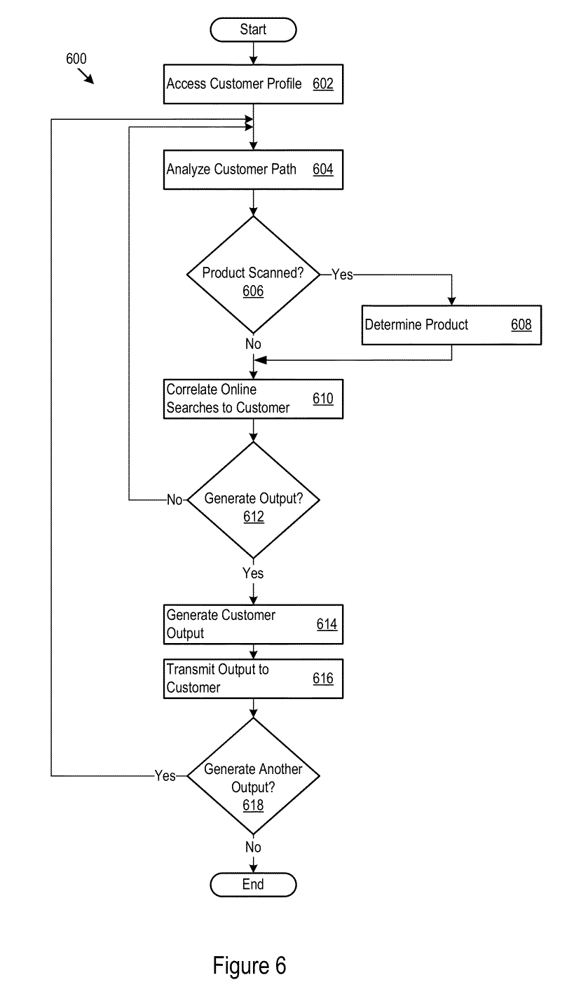

A customer's purchase intent may indicate why the customer visited the store or the customer's interest in a type of product/service or a brand of product/service. The online/in-store analysis system 140 may determine the customer's purchase intent based on the customer's in-store activity and/or customer online data. As discussed in more detail below, the online/in-store analysis system 140 may identify the customer and/or track activity of the customer within the store in one of several ways. One way is to receive an automatic input from the customer device 110. The customer device 110 may be a mobile telephone or a smartphone executing an online/in-store analysis mobile application. Moreover, the customer device 110 may transmit positioning data through a positioning device such as a global positioning system (GPS). The customer device's positioning device may therefore provide data to allow the online/in-store analysis system 140, and particularly the intent analysis engine 146, to analyze the walking path of the customer within the store. Another way to identify and/or track the customer's in-store activity is by using a scanning device, which allows the customer to scan and transmit the bar code of a particular in-store product to the online/in-store analysis system 140. The online/in-store analysis system 140 may receive the customer's in-store activity data through the communication interface 145 and transmit the in-store activity data to the intent analysis engine 146. Next, the intent analysis engine 146 may determine a customer's purchase intent by analyzing the received in-store activity data, as discussed in more detail in FIG. 6.

The online/in-store analysis system 140 may also determine a customer's purchase intent based on any number of use inputs. For example, the online/in-store analysis system 140 may send a purchase target query to the customer, querying the customer as to who a customer intends to purchase a product or service for. The online/in-store analysis system 140 may receive a purchase target indication from the customer, which may indicate, as an example, whether the customer is shopping for themselves or for another, e.g., a friend, a relative, a social connection from any of the customer's social network. In one implementation, the purchase target indication may also include a target identity when the customer is shopping for another. As discussed below, the online/in-store analysis system 140 may generate an output to a store customer according to the customer's purchase intent, including the purchase target.

Once the online/in-store analysis system 140 has generated a customer profile, determined a customer's purchase intent, and retrieved general customer data and/or general store data, the output analysis engine 148 may generate a store output 150 and/or a customer output 160. The store output 150 may include information concerning the customer, such as the customer's purchase intent, the customer's online activity history, the customer's background, and/or a suggested activity for the sales person (such as a suggestion as to a particular product for purchase). The store output 150 may also include a customer's browsing history (online or in-store), any number of customer interests unrelated to the purchase intent, or additional product data with respect to the customer's purchase intent.

In one implementation, the online/in-store analysis system 140 may also obtain product inquiry data. For example, the online/in-store analysis system 140 may access any number of external databases, such as the databases implemented on the store server 130, to retrieve common customer product inquiries of a particular product or service with respect to the customer's purchase intent, e.g., product inquiries that exceed a predetermined frequency parameter or a predetermined number of the product inquiries with the highest frequency. The product inquiry data may comprise customer inquiries from any number of sources, such as the particular store the customer is present in, stores within a particular geographic boundary, inquiries originating from the Internet, e.g., from the store's online website, or other sources. The store output 150 may include the retrieved product inquiry data to inform a store sales person of common questions regarding a certain product or service.

With the store output 150, the store sales person 138 may interact with the customer by making relevant and purposeful product suggestions to the customer. The output analysis engine 148 may select a store sales person based on the customer's background, the customer's purchase intent, and/or the store sales person's areas of sales expertise or common interests with respect to the customer, including common interests unrelated to the customer's purchase intent. After a store output 150 has been generated by the online/in-store analysis system 140, the store output 150 may be transmitted to the store server 130 and communicated to the selected sales person. For example, the online/in-store analysis system 140 may transmit the store output 150 to a mobile electronic device of the selected sales person.

The customer output 160 may include any type of information to assist a customer in purchasing a product in the store. For example, the customer output 160 may include one or more suggestions or offers, including a suggested store product that the customer may be interested in viewing based on the customer's purchase intent or potential discounts/current product promotions in effect at the store that relate to a customer's purchase intent. The customer output 160 may also include any combination of product information based on the customer's purchase intent or product information of additional, e.g., similar, products viewed or purchased by the customer's social connections or persons matching a similarity criteria.

As additional examples, the customer output 160 may include a customized image or a customized description of a product or service based on the customer's online or in-store data. For instance, the online/in-store analysis system 140 may generate a customer output 160 that includes product feedback, e.g., product reviews or product feedback, from any combination of the customer's social connections or reviewers matching similarity criteria, such as age, education, demographic criteria, with respect to any of the attributes described below in FIG. 4, or others. When the determined purchase intent indicates the customer is shopping for another, e.g., not for themselves, the online/in-store analysis system 140 may generate a customer output 160 based on a purchase target's online or in-store data, e.g., purchase history, interest data, browsing history, etc. After a customer output 160 has been generated by the online/in-store analysis system 140, the customer output 160 may be transmitted to the customer device 110 and communicated to the customer via the network 170.

In one implementation, the online/in-store analysis system 140 may also allow the customer to solicit feedback with respect to the customer output 160 or a particular product, e.g., soliciting real-time feedback while the customer is in the store. The online/in-store analysis system 140 may receive a feedback solicitation indication from the customer, such as through a user interface. In response, the online/in-store analysis system 140 may solicit feedback concerning a particular product or service in any number of ways. In one instance, the online/in-store system 140 may transmit a feedback solicitation communication to a social network, e.g., by generating a Facebook® post. The online/in-store analysis system 140 may identify when a customer's social connections have responded to the feedback solicitation via the social network, such as when a customer's social connections respond to the feedback solicitation communication. Or, the online/in-store analysis system 140 may utilize an external polling function to solicit feedback, such as by creating a poll through a polling website operated on the Internet. In another implementation, the online/in-store analysis system 140 may populate an e-mail template with a feedback request, and request a customer enter contact information, e.g., e-mail addresses, of persons the customer requests feedback from.

Upon soliciting feedback, the online/in-store analysis system 140 may then aggregate the feedback results and present the received feedback to the customer, such as in real-time as feedback is received or after a predetermined timing parameter. In one implementation, the online/in-store analysis system 140 may solicit feedback for a particular product or service by presenting selection options to solicitation targets, e.g., a customer's social connections. Upon receiving feedback, the online/in-store analysis system 140 may present the feedback results according to the frequency each respective selection option was selected by persons responding to the feedback solicitations.

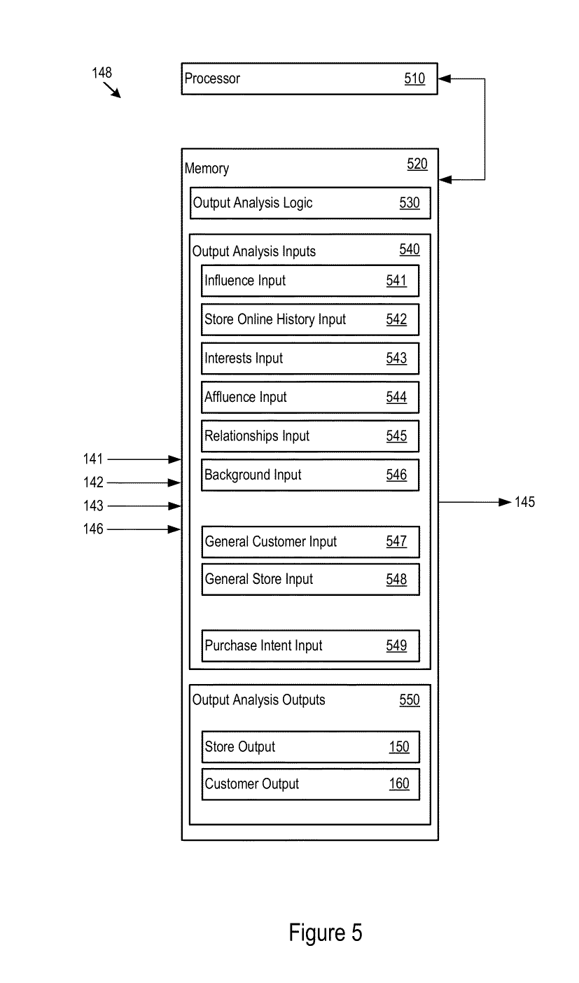

The online/in-store analysis system 140 further includes one or more memories coupled to one or more processors. Analysis logic may support operation of the intent analysis engine 146, the attribute analysis engine 147 and the output analysis engine 148. The analysis logic may be implemented as processor executable instructions stored in the memory and executed by the processor. As one example, FIG. 5 describes, in detail, the execution of the output analysis engine 148 through a processor, memory, and output analysis logic implemented as processor executable instructions. Both the customer device 110 and the store server 130 may include memory storing the analysis logic in communication with a processor, allowing the online/in-store analysis system 140 to operate. In one implementation, the online/in-store analysis system 140 may be stored on the customer device 110. Alternatively, the online/in-store analysis system 140 may be stored on the store server 130 or on a separate computing device.

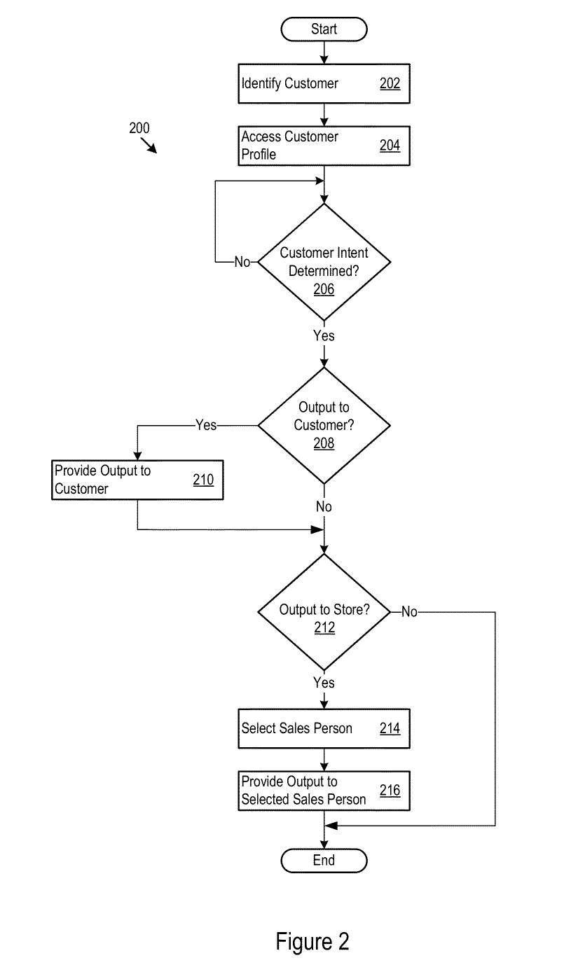

FIG. 2 illustrates a flow chart of the process 200 of the online/in-store analysis system 140 interacting with the customer and/or a sales person. The process 200 may be initiated in one of several ways. For example, the process 200 may be triggered upon the customer's entry into the store. In this example, the customer device 110 may automatically alert the online/in-store analysis system 140 when the customer has entered a store. In one respect, the customer device 110 may constantly poll the location of the customer. By continually receiving the customer's positioning signal, the online/in-store analysis system 140 may determine when the customer has entered the store. Alternatively, an external data source 120, such as Facebook®, may allow for the customer to broadcast their current location through a “check-in” feature, also allowing the online/in-store analysis system 140 to determine when the customer has entered the store. In another implementation, the customer may log-in to an application that implements or interacts with the online/in-store analysis system 140, e.g., a mobile app, thus initiating the process.

Once a triggering event has been detected, the online/in-store analysis system 140 identifies the customer (202). As discussed above, the customer may be identified automatically (such as via the mobile application running on the customer device 110) or manually (such as via a manual input of the customer). Once the customer has been identified, the online/in-store analysis system 140 may access the customer profile (204) from the customer profile database 142. Next, the online/in-store analysis system 140 may determine the purchase intent of the customer (206). If no purchase intent has been determined, the online/in-store analysis system 140 may continue to poll the customer device 110. The customer's purchase intent may be detected in various ways, as discussed briefly above and in detail below in FIG. 6.

Next, the online/in-store analysis system 140 may determine whether to provide the customer with an output (208). If so, the customer output 160 is provided to the customer (210), for example by transmitting the customer output 160 to an output device associated with the customer, e.g., an electronic or mobile device. The online/in-store analysis system 140 also determines whether to provide an output to the store (212). If so, online/in-store analysis system 140 may select a store sales person (214). The store output 150 is then transmitted to the store (216), e.g., an electronic device operated by the store, and to the selected store sales person, e.g., via an electronic terminal, store equipment, an electronic or mobile device associated with the store sales person, etc.

FIG. 3 illustrates a flow chart 300 for generating and updating a customer profile. The customer profile may be generated based on one or more sources of data, such as the customer online data. Furthermore, the customer profile may include one or more customer attributes. As discussed in more detail below, the customer attributes may be based, at least in part, on the customer online data.

In one embodiment, the customer attributes may be determined using the customer online data and the historical customer in-store data. Once the online/in-store analysis system 140 has determined to generate or update a customer profile (302), the online/in-store analysis system 140 may retrieve customer data from the individual customer database 143 (304), including customer online data and historical customer in-store data. As discussed above, the customer online data stored in the individual customer database 143 may identify the online data generated by the customer and received from external data sources 120 and the store server 130. The historical customer in-store data may identify the customer's previous in-store activities, as received from the store server 130 or the individual customer database 143. By way of example only, the customer profile may include a customer affluence attribute, interests attribute, background attribute, influence attribute or store online history attribute.

The customer data (e.g., the customer online data and/or historical customer in-store data of a customer) may be updated periodically. For example, at one or more predetermined intervals, the online/in-store analysis system 140 may determine whether to update the customer data (306). For example, the online/in-store analysis system 140 may update customer online data by obtaining additional customer online data or updating the customer online data stored in the individual customer database 143. A similar process may be employed to update the historical customer in-store data. If the online/in-store analysis system 140 decides not to perform an update, the customer profile may be updated (312) with the customer online data and historical customer in-store data retrieved from the individual customer database 143. On the other hand, the online/in-store analysis system 140 may decide to update the customer online data by retrieving the customer online data from the external data sources 120 and the store server 136 (308). The online/in-store analysis system 140 may also retrieve updated historical customer in-store data from the store server 130 (309). Once the updated customer data has been obtained, the online/in-store analysis system 140 may compare the newly retrieved customer online data and historical customer in-store data with the previously obtained customer data stored in the individual customer database 143. This comparison may determine whether any attributes were affected by the customer data update (310). If so, the online/in-store analysis system 140 may update the customer profile (312), either by updating the affected customer attributes or by generating an entire customer profile (i.e., updating every customer attribute).

The process of updating a customer attribute may vary depending on the particular customer attribute, as depicted in FIG. 4, which illustrates a flow chart 400 for updating a customer attribute. First, the attribute analysis engine 147 may receive a customer profile to update (402) along with the customer data (404). The customer data received by the attribute analysis engine 147 may include customer online data and historical customer in-store data. One option to obtain online customer data is through data mining. For example, the online/in-store analysis system 140 may include network analysis software, which is capable of sorting through the influx of social networking data for any specific company. Alternatively, the online/in-store analysis system 140 may receive the online customer data from an external source. For example, Facebook® offers various services such as the “Social Ads” program that provides access to the millions of profiles, or the “Facebook Beacon” program that tracks the websites a user uses outside of Facebook®.

Then, the online/in-store analysis system 140 may select which customer attribute to update in the customer profile (410). Generally, the attribute analysis engine 147 may update a customer attribute by first identifying customer data relevant to the selected customer attribute (e.g., 420, 432, 440, 450, 460, 470) and then analyzing the identified customer data to update the selected customer attribute (e.g., 422, 434, 442, 452, 462, 472). FIG. 4 provides six examples of customer attributes that may be stored within a customer profile in the online/in-store analysis system 140—a customer's (1) influence attribute, (2) store online history attribute, (3) affluence attribute, (4) interests attribute, (5) relational attribute and (6) background attribute. The online/in-store analysis system 140 may utilize customer attributes, individually or in combination, to analyze the potential purchasing activity of a customer, such as products the customer may be more interested in or more likely to purchase. The examples of customer attributes in FIG. 4 are merely for illustration purposes. Other customer attributes are contemplated.

With respect to the specific customer attributes depicted in FIG. 4, the attribute analysis engine 147 may update the influence attribute. The influence attribute may measure the customer's influence on the purchasing activity of other people. For example, a customer may broadcast a purchase of a recent product through social media (i.e., Facebook®, Google+®, Twitter®) or other means. If a store recognizes increased sales of the broadcasted product, the customer may have a strong influence upon the purchase activity of others, with this strong influence indicated by the influence attribute.

To update the influence attribute, the attribute analysis engine 147 may first identify the customer influence data (420), i.e., data relevant to determining the customer's influence on the purchasing activity of other people. Customer influence data may include a customer's social media activity or other means through which a customer may broadcast the purchase of a product. In order to track the customer's impact on purchase activity, the customer influence data may also identify customer relationships, such as identifying a customer's friends on Facebook®, follower's on Twitter®, or circles in Google+®. Similarly, the store server 130 may also provide the sales log of any customer-broadcasted products or of any products purchased by the customer.

In analyzing customer influence (422), the attribute analysis engine 147 may leverage the received customer influence data to determine the influence of a customer. For example, influence may be directly attributed to the customer if the customer's identified relationships purchase a product soon after the customer's product broadcast. Alternatively, the attribute analysis engine 147 may indirectly determine customer influence by observing an increase of a particular product's sales subsequent to a customer's purchase of the particular product (with or without an identified broadcast). Customer influence may be quantitatively measured by allocating influence values depending on the degree of subsequent purchase activity that may be attributed to a customer. Additionally, a customer's influence may vary depending on a particular type of product, a particular segment of population, or other criteria.

The attribute analysis system 147 may also set an influence threshold. The online/in-store analysis system 140 may generate varying outputs depending upon a customer's influence attribute in relation to the influence threshold. For example, in FIG. 4, the attribute analysis engine 147 may measure whether (and to what extent) a customer's analyzed influence attribute exceeds a predetermined influence threshold. If the customer's influence attribute exceeds the threshold, the attribute analysis engine 147 may generate a potential discount (424). When generating, a customer output (160), the online/in-store analysis system 140 may transmit the potential discount to the customer to enhance the customer's in-store experience.

The attribute analysis engine 147 may also update the store online history attribute. The store online history attribute may track the customer's activity on the store's website. First, the attribute analysis engine 147 may determine whether the customer has an online account with the store. If so, the attribute analysis engine 147 may then identify the customer online history data (430) from the store server 130. Customer online history data (i.e., customer data relevant to the store online history attribute) may include the customer's online browsing history of products on the store website, and may be tracked by cookies on an internet web browser or by the store web server. The customer online history data may also include the customer's purchase history at the online store, including the price, the model, and the date of products purchased by the customer. Other customer online data relevant to the customer's store online history attribute may also be identified by the attribute analysis engine 147.

If the customer does not have an online store account, the attribute analysis engine 147 may correlate general store browsing history to the customer (434). The attribute analysis engine 147 may receive from the store server 130 general store browsing history attributable to a geographic zip code or another delineating characteristic. By analyzing the general browsing history, the attribute analysis engine 147 may attribute a portion or sequence of the store browsing history to the customer as the customer's online history data.

Next, the attribute analysis system 147 may analyze the customer online activity data (432). The customer's browsing history may indicate potential products and product brands the customer may be interested in purchasing. The browsing history sequence trends and the differences in sequentially browsed products may suggest the product characteristics the customer may favor (such as price, brand, or specific product features). The customer's online purchase history may further indicate a customer's preference in products, the price class of products the customer purchases, and the length in time since the customer last purchased particular products or types of products. Based on the customer's store online history data, the attribute analysis engine 147 may leverage the relevant customer information to update the store online history attribute of the customer profile.

The attribute analysis engine 147 may also update the affluence attribute. The affluence attribute may predict the customer's financial status to analyze the products a customer is more likely to purchase. First, the attribute analysis engine 147 may identify the customer affluence data (440). Customer affluence data may include all customer data relevant to predicting a customer's financial status, including a customer's level of education, current employment, employment history, place of residence, or other relevant customer online data.

Next, the attribute analysis engine 147 may analyze the customer affluence data (442) in order to predict the customer's current financial status. To do so, the attribute analysis engine 147 may use the identified affluence data to predict a customer's income bracket, financial stability, or other financial determinations relating to the customer. As an example, a customer's current occupation may be compared with median salaries for the customer's job position, and may factor in experience and length of employment. Or, the customer's address of residence may indicate the customer's class of income (i.e. lower middle class, extremely wealthy, etc.) based on the purchase price of the property or the general wealth of the neighborhood or city. By predicting the customer's financial status through the affluence attribute, the online/in-store analysis may consider such factors in determining the customer's potential purchasing activity in the store.

The attribute analysis engine 147 may also update the interests attribute, which may relate to a customer's personal interests and preferences. For example, the interests attribute may track a customer's preference in leisure activities, sports teams, media (e.g., movies, books, television shows), or other personal interests. The interests attribute may also reflect a customer's preference in products, such as color or brand. First, the attribute analysis engine 147 may identify customer interest data (450), such as the customer's personal interests listed above. Customer interest data may be found in external data sources 120 such as Facebook®, Twitter®, or Google+®. Additionally, customer interest data may include the customer's online store purchase history, in-store purchase history, or online browsing history, as found in the store server 130. Next, the attribute analysis system 147 may analyze the customer interest data (452) to determine how and which customer interests affect the customer's potential purchasing activity. For example, attribute analysis engine 147 may identify that a customer enjoys watching sports as a primary leisure activity. This customer information may be leveraged to predict whether a customer may be more willing to purchase a 50 inch, high definition (HD) television as opposed to non-HD, smaller television models. As may be true with other customer attributes, the extent to which the interests attribute affects a customer's potential purchasing activity may depend on the particular product evidenced by the customer's purchase intent (which is also the particular product the generated customer output 160 or store output 150 is based on).

Concerning the relationship attribute, the attribute analysis engine 147 may first identify customer relationship data (460). The relationship attribute may relate to how a customer's potential purchasing activity is affected by a customer's relationships. As such, the online/in-store analysis system 140 may retrieve a customer's relationship data through social media sources, such as friends on Facebook®, followers on Twitter®, contacts on LinkedIn®, or circles in Google®+. In addition to determining the identities of a customer's relationships, the attribute analysis engine 147 may also identify customer relationship data related to the customer relationships, such as important dates (birthdays, anniversaries, events), degree of relationships (family, friends, acquaintances, current work colleagues, former work colleagues), shared interests, or other relevant customer relationship data.

Next, the attribute analysis engine 147 may analyze the customer relationship data (462) to determine how a customer's relationships affect the customer's potential purchasing activity. Specifically, the relationship attribute may indicate when the customer is purchasing a product as a gift for a family member, friend, or colleague. For example, the attribute analysis engine 147 may identify that the customer's Facebook® “Events” data includes an upcoming baby shower for a work colleague. The relationship attribute may affect the customer output 160 by prompting the online/in-store analysis to suggest products differing from the product identified by the customer's presently determined purchase intent (for example, the product a customer scans with the customer device 110). The relationship attribute may allow the online/in-store analysis system 140 to suggest different types of baby products unrelated to the customer's present purchase intent (i.e., the scanned product), and may also prompt the output analysis engine 148 to suggest additional, complimentary products, such as a baby shower card or a gift bag.

According to FIG. 4, the attribute analysis engine 147 may also update the customer background attribute. A customer's background attribute may indicate general information about a customer, such as the customer's age, birth date, marital status, education level, contact information, or other relevant general information about the customer. First, the attribute analysis engine 147 may identify customer background data (470). Sources of customer background data may include external data sources 120 such as social media or the store server 130, which stores customer information relating to a customer's online store account. Next, the customer's background data may be analyzed (472).

Regardless of which attribute is chosen for update, after a customer attribute is analyzed, the online/in-store analysis system 140 may update the customer profile (420) to store the results of the attribute analysis process. Next, the online/in-store analysis system 140 may update another attribute (490). The update process may be repeated for each customer attribute that was affected when the online/in-store analysis system 140 obtained additional customer data, as depicted in FIG. 3 (306). Once, all the affected attributes have been updated, the attribute analysis and update process may end.

FIG. 5 shows an example implementation of an output analysis engine 148. In the example in FIG. 5, the output analysis engine 148 includes a processor 510 coupled to a memory 520. The output analysis engine 148 may receive inputs from multiple sources in the online/in-store analysis system 140, including the general customer database 141, the customer profile database 142, the individual customer database 143, and the intent analysis engine 146. The output analysis engine 148 may store the received inputs as output analysis inputs 540 in the memory 520. The output analysis inputs 520 may include multiple customer attributes (e.g., an influence input 541, an store online history input 542, an affluence input 543, an interests input 544, a relationships input 545, and a background input 546), a general customer input 547, a general store input 548, and a purchase intent input 549. Customer attributes may provide insight into a customer's potential purchase activity and were previously discussed in FIG. 4. The general customer input 547 may refer to customer data derived from a class of customers, such as males between the age of 25 and 40, doctors, or data on customers from the state of Hawaii. The general store input 548 may refer to data concerning the particular store the customer has entered, such as product inventories, a list of store sales persons including sales areas of expertise, and the store sales data for both particular products and as a whole. The purchase intent input 549 may indicate a customer's purchase intent, i.e., why the customer visited the store or the customer's interest in a type of product/service or a brand of product/service. The output analysis engine 148 may generate output analysis outputs 550, including the customer output 160 and the store output 150, to transmit through the communication interface 145 of the online/in-store analysis system 140.

The example output analysis engine 148 depicted in FIG. 5 includes output analysis logic 530, stored in the memory 520. The output analysis logic 530 may be implemented as processor executable instructions that direct the output analysis process of receiving the output analysis inputs 540 and generating the output analysis outputs 550.

The customer output 160 may suggest a particular store product for the customer to consider, and may depend directly on the customer's detected purchase intent. For example, the online/in-store analysis system 140, and specifically the intent analysis engine 147, may determine that a customer's purchase intent is to purchase a new television. The output analysis logic 530 may direct generate a customer output 160 reflecting the customer's purchase intent, e.g., by suggesting a particular television product for the customer to consider. The determined purchase intent may initially direct the analysis of the output analysis logic 530. Based on the type of product evidenced by the purchase intent, the output analysis logic 530 may consider each customer attribute to determine the proper store product to suggest to the customer. Additionally, the output analysis logic 530 may recognize that the received general customer data may be applicable to the particular customer and the output analysis process. For example, the general customer data may suggest that 90% of a particular population segment, to which the customer belongs, prefer black colored television sets over gray colored television sets. The output analysis logic 530 may integrate the general customer data in the output analysis process if the customer attributes of the particular customer do not provide any direction to the customer's color preference (or, alternatively, even if they provide contrary direction).

In addition to suggesting a product based on the customer's purchase intent, the output analysis logic 530 may provide a potential discount based on the customer's influence attribute, as discussed in FIG. 4. Also, as discussed in the baby shower example above, the output analysis logic 530 may suggest a type of product unrelated to the specific product identified in the customer's purchase intent based on the customer's relationship attribute, or another customer attribute.

In generating the store output 150 or the customer output 160, the output analysis logic 530 may reconcile data from the output analysis inputs 540 that suggest conflicting determinations about the customer. As an example, a customer's affluence attribute, interests attribute, and background attribute may suggest that the customer is financially capable and interested in owning a large HD flat-screen television built in the last two years. However, the customer's store online history attribute may suggest that the customer has not purchased a television in more than five years, and other technological product purchases were infrequent. Consequently, the output analysis logic 530 may weigh the multiple inputs differently in generating a customer output 160 or store output 150. The output analysis logic 530 may give certain customer attributes greater weight or lesser weight in generating the output analysis outputs 550, and input data weights may vary by configuration of the output analysis logic 530. Numerical weights may be assigned to the output analysis inputs 540 to quantify how the output analysis logic 530 weighs each specific input in the output analysis process.

In addition to the customer output 160, the output analysis engine 148 may also generate a store output 150. As part of the store output analysis process, the output analysis logic 530 may utilize data from the general store input 548. Specifically, the general store data may include data on store sale persons, allowing the output analysis logic 530 to select a store sales person 138 to interact with the customer. A store sales person 138 may be selected on the basis of their current availability (e.g., whether they are working that day, whether they are occupied with another assigned task, or other relevant availability factors), areas of sales expertise, or shared similarities with the customer. In addition to selecting a store sales person 138, the output analysis logic 530 may generate a store output 150 that the online/in-store analysis system 140 may transmit to the selected store sales person. The store output 150 may include customer data, including the customer's purchase intent and potential purchasing activity. Thus, the store output 150 may assist the selected store sales person in recommending relevant store products or promotions to the customer, allowing the selected store sales person to leverage an analysis of the customer online data and activity to enhance the customer's in-store experience.

The output analysis logic 530 may also generate an updated store output 150 or customer output 160 due to the detected change in the output analysis inputs 540. For example, the customer may use the customer device 110 to scan a television, allowing the intent analysis engine 146 to detect and determine a customer's purchase intent. However, the customer may later scan a laptop computer, evidencing that the customer's present purchase intent has changed. The changed customer purchase intent may be transmitted to the output analysis engine 148, whereupon the output analysis logic 530 may generate an updated store output 150 or customer output 160 based on the customer's new purchase intent directed to laptop computers.

FIG. 6 shows a flow chart 600 for generating a customer output 160 to a customer. FIG. 6 also provides insight into understanding how the intent analysis engine 146 may determine a customer's purchase intent. As discussed above, the online/in-store analysis system 140 may detect a triggering event, before beginning the online/in-store analysis process, such as when the customer enters the store. Upon occurrence of the triggering event, the online/in-store analysis system 140 may access the customer profile of the customer (602).

Next, the online/in-store analysis system 140 may identify the purchase intent of the customer through the intent analysis engine 146. FIG. 6 shows one example of how an intent analysis engine 146 may determine a customer's purchase intent. The intent analysis engine 146 may receive one or more purchase intent inputs, such as the customer's walking path in the store. As discussed above, the customer device 110 may include a positioning device, such as a GPS device, that provides position information of the customer to the online/in-store analysis system 140. In receiving the customer's walking path in the store, the intent analysis engine 146 may analyze the customer's path to determine a customer's purchase intent. Relevant analysis may include analyzing the customer's current location in the store, the direction the customer is walking, and the walking speed of the customer (including a speed of zero, i.e., the customer has stopped). For example, upon entering the store, the customer may walk towards the television section of the store, indicating a potential purchase intent. Conversely, the customer may walk towards the store's customer service desk, signaling a different or a lack of customer purchase intent. The intent analysis engine 146 may additionally analyze the customer's walking path to consider where a customer stops. Again, the customer may walk towards the television section of a store, but continue walking past the television section and stopping at the laptop section of a store. Thus, the intent analysis engine 146 may then determine a customer purchase intent directed towards laptop computers instead of televisions. The intent analysis engine 146 may continually perform the purchase intent analysis depending on the customer walking path input to determine an up-to-date and accurate assessment of the customer's present purchase intent.

Next, the intent analysis engine 146 may determine whether the customer scanned a product using a bar code scanner on the customer device 110 (606). If a product was scanned by the customer, the online/in-store analysis system 140 may then determine the specific product the customer scanned (608), including the type of product, as well as the specific product itself. The type of product may be highly relevant in determining a customer's purchase intent. If the customer stopped and scanned a particular laptop computer, the intent analysis engine146 may ascertain the customer's purchase intent (i.e., that the customer has expressed interest in laptop computers or may be potentially purchasing a laptop computer).

The intent analysis engine 146 may also leverage customer online data in order to determine the customer's purchase intent. For example, the intent analysis engine 146 may determine a customer's purchase intent by correlating online searches to a customer (610). If the customer has an online store account, the intent analysis engine 146 may directly attribute a customer's online browsing history on the store website to the customer. By analyzing the products browsed on the store website as well as the sequence of the customer's product browsing, the intent analysis engine 146 may ascertain the types of products a customer has expressed interest in or may potentially purchase, thereby determining the customer's purchase intent. If the customer does not have an online store account, the intent analysis engine 147 may also receive from the store server 130 general store browsing history attributable to a geographic zip code or other delineating characteristic. By analyzing the customer's walking path in conjunction with the general store browsing history, the intent analysis engine 146 may attribute a sequence of general online store browsing to a customer, thereby providing purchase intent data to the intent analysis engine 146.

Next, the online/in-store analysis system 140 may determine whether to generate a customer output 160 (612). Even when a customer's purchase intent is detected, the online/in-store analysis system 140 may elect not to generate a customer output 160 at a current point in time. For instance, the intent analysis engine 146 may predict a customer's purchase intent by analyzing the customer's walking path. However, the online/in-store analysis system 140 may elect to generate a customer output 160 only when additional purchase intent data has been received, such as after the customer has scanned a product with the customer device 110. On the other hand, if a certain amount of time has elapsed and the only purchased intent data received by the intent analysis engine 146 is in the form of a customer's walking path, the online/in-store analysis system 140 may elect to generate a customer output 160 for the customer based on the current purchase intent indicated by the customer's walking path alone. Similar criteria may be enacted to control the timing of when the online/in-store analysis system 140 generates a customer output. If the online/in-store analysis system 140 does not elect to generate a customer output 160, the purchase intent determination process may continue as the intent analysis engine 146 continues to receive updated and/or additional purchase intent data.

If the online/in-store analysis system 140 elects to generate a customer output 160 based on the presently determined purchase intent, the output analysis engine 148 may generate the customer output 160 (614). Then, the online/in-store analysis system 140 may transmit the generated customer output 160 to the customer (616). The output may be transmitted to the customer through various means. In one respect, the output may be transmitted and displayed to the customer through the customer device 110, such as through a smartphone and mobile online/in-store analysis application. Additional mediums of transmission may include transmitting the output by e-mail or through an external data source 120, such as Facebook® or Twitter®. In one implementation, the online/in-store analysis system 140 may also transmit a feedback solicitation option to the customer, e.g., with respect to the generated output.

After a first customer output 160 has been generated, the online/in-store analysis system 140 may also determine whether to generate another customer output 160 (618). For example, the online/in-store analysis system 140 may elect to cease generating customer outputs 160 when the customer has left the store. Other criteria in ceasing the generation of customer outputs 160 may include the lapse of a fixed amount of time or a maximum number of generated customer outputs 160 within a predetermined time period. If such stopping criteria are met, the online/in-store analysis system 140 may elect not to generate another customer output 160.

If the stopping criteria have not been met, the online/in-store analysis system 140 may elect to generate another output by continuing the intent analysis and determination process. The intent analysis engine 146 may continue to receive purchase intent data to presently determine the customer's purchase intent. Such a situation may occur if the customer scans a new type of product, prompting the online/in-store analysis system 140 to generate another customer output 160 based on the newly determined purchase intent directed towards the newly scanned type of product. As another example, the customer may scan a similar type of product, allowing the online/in-store analysis system 140 to generate an additional customer output 160 based on the sequence of products scanned by the customer. The online/in-store analysis system 140 may generate another customer output 160 in additional circumstances as well.

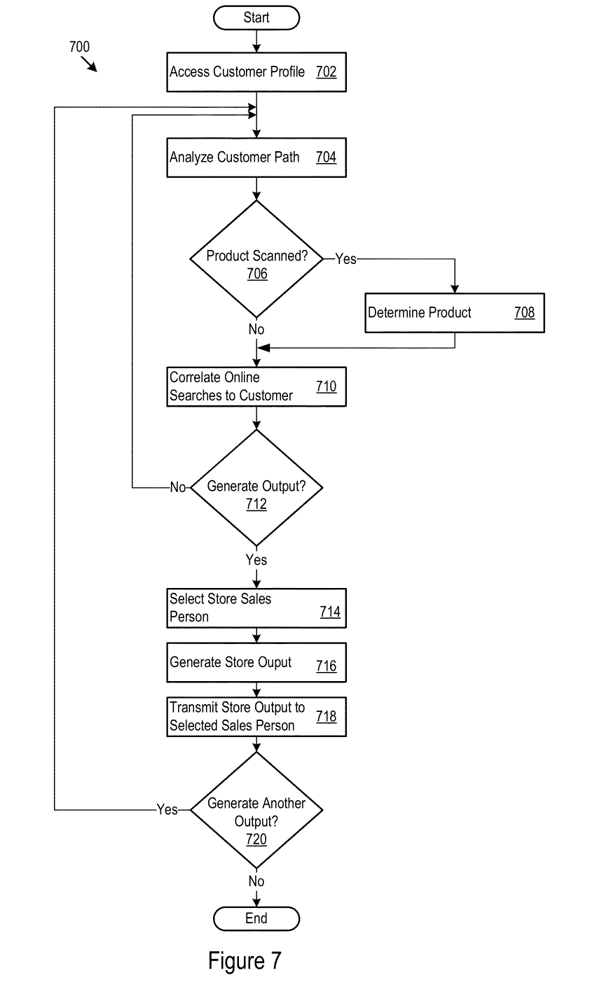

FIG. 7 illustrates a flow chart 700 for generating an output to a store sales person 138. Similar to the process for generating a customer output 160 depicted in FIG. 6, generating a store output 150 may include first accessing the customer profile (702) after a triggering event and then determining the customer's purchase intent. As shown in FIG. 6, the customer's purchase intent may be determined by analyzing the customer's walking path (704), determining whether a product has been scanned by the customer (706), determining the product scanned by the customer (708), and correlating online store browsing history to the customer (710).

Furthermore, the online/in-store analysis system 140 may determine whether to generate a store output 150 (712). Once the online/in-store analysis system 140 has determined to generate a store output 150, a store sales person 138 is selected (714), e.g., by the online/in-store analysis system 140. As discussed above, multiple store sales persons may be potentially available. Given the available data stored in the online/in-store analysis system databases (such as the customer profile and the customer's purchase intent), one of the store sales people 138 may be selected by the online/in-store analysis system 140. The output analysis engine 148 may generate a store output 150 (716) and the store output 150 may be transmitted to the selected store sales person (718). The online/in-store analysis system 140 then determines whether to generate another store output 150 (720). For example, the online/in-store analysis system 140 may predict a customer's purchase intent based on correlating online browsing history to the customer. Shortly upon entering the store, the online/in-store analysis system 140 may first select a store greeter to transmit a generated store output 150 to, allowing the store greeter to direct the customer to store areas matching the customer's predicted purchase intent. Upon identifying the customer's walking path or scanning of a product, the online/in-store analysis system 140 may determine an updated purchase intent or confirm the previously predicted purchase intent. In either situation, the output analysis engine 148 may select another store sales person 138 to transmit a second generated store output 150 to. The online/in-store analysis system 140 may employ criteria to determine when to generate another store output 150. In this way, the online/in-store analysis system 140 may iteratively determine whether (and how) to interact with the customer using the store sales persons.

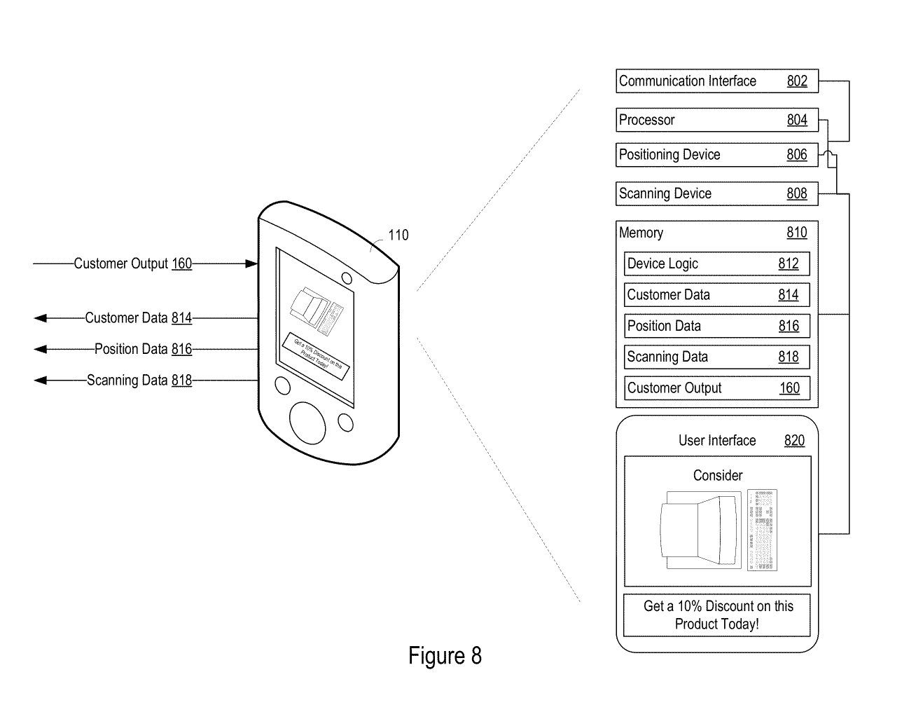

FIG. 8 shows an example of a customer device 110. In the example shown in FIG. 8, the customer 110 device includes a processor 804 in communication with a communication interface 802, a positioning device 806, a scanning device 808, a memory 810, and a user interface 820. The memory 810 includes device logic 812, customer data 814, position data 816, scanning data 818, and the customer output 160.

The device logic 812 may be implemented as processor executable instructions to direct the interaction of the customer device 110 with the online/in-store analysis system 140. For example, the device logic 812 may form an online/in-store analysis mobile application, executed on the customer device 110 to interact with the online/in-store analysis system 140. In operation, the device logic 812 may transmit customer data 814, position data 816, or scanning data 818 to the online/in-store analysis system 140 through the customer device's communication interface 802. The customer data 814 may identify the customer using the customer device 110, allowing the online/in-store analysis system 140 to identify the specific customer whose customer online data may be retrieved in executing the intent analysis and output analysis processes. As discussed above, the position data 816 and the scanning data 818 may be transmitted to the online/in-store analysis system 140, and may be relevant to the intent analysis process as purchase intent data. The position data 816 may be captured by the positioning device 806, such as a GPS device. The scanning data 818 may be captured by the scanning device 818. In one implementation, the scanning device may be camera attached to the customer device 110. The camera may capture a bar code image of a product and the device logic 812 may interpret the camera image to determine the scanning data 818 of the product.

The customer device 110 may also receive a customer output 160 from the online/in-store analysis system 140. The device logic 812 may display the customer output 160 through the user interface 820. The user interface 820 may be implemented as a graphical user interface (GUI) on the customer device 110, displayed through a liquid crystal display (LCD) screen. In the implementation shown in FIG. 8, the device logic 812 displays the customer output 160 (e.g., a suggested product and a product discount) through the user interface 820.

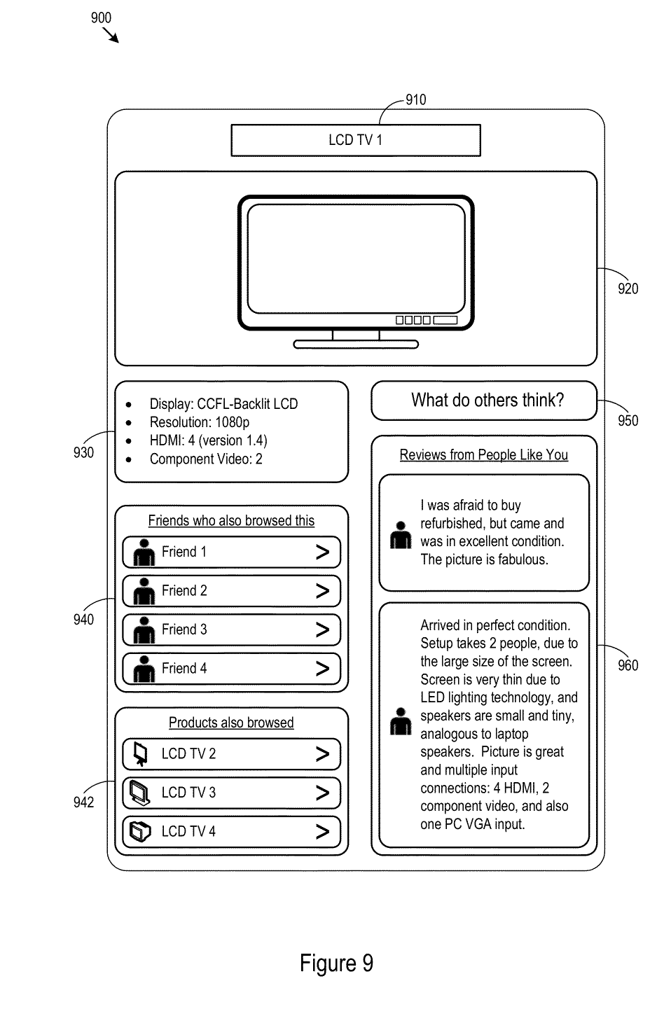

FIG. 9 shows an example of a customer output 900. The customer output 900 may be displayed through device logic 812 through a user interface 820. In one implementation, the online/in-store analysis system 140 may generate the customer output 900 based on a customer's purchase intent, e.g., when the customer has scanned a particular product barcode or QR code in the store, the customer profile, customer in-store data, customer online data, online or in-store data with respect to other shoppers or the customer's social connections, or other data. In the example shown in FIG. 9, the online/in-store analysis system 140 may generate the customer output 900 after obtaining product indication, e.g., via a product barcode, a QR code, or any other identifying data for a particular product, e.g. LCD TV 1.

The customer output 900 may include any amount of information related to a particular product or service, including any combination of the product information shown in FIG. 9. The product or service information may be generated specifically based on the customer or other's online and in-store data. In FIG. 9, the customer output 900 includes a product name 910, which may identify a particular product scanned by a customer or identified/suggested upon determining the customer's purchase intent. The exemplary customer output 900 shown in FIG. 9 also includes a customized product image 920, customized product description 930, social network feedback information 940, a similar products listing 942, a feedback solicitation option 950, and similar persons feedback information 960.

In one implementation, the customer output 900 may include information personalized to the customer. For example, the customized product image 920 may display an image of a particular product based on any portion of the customer's online data, in-store data, or both. The online/in-store analysis system 140 may access a database comprising multiple images of a product and determine a selected image based on the customer profile of a customer or any combination of any of the customer attributes discussed above. The online/in-store analysis system 140 may also generate a customized product description based on the customer's online data, in-store data, or both. In one example, the online/in-store analysis system 140 may categorize a customer into a predetermined customer segment based on any portion of the customer's online data, in-store data, or both. The online/in-store analysis system 140 may then select a customized product image and generate a customized product description based on the determined customer segment of the customer.

To illustrate, the online/in-store analysis system 140 may identify that a customer is a mother of 2 and grandmother of 3 with limited technical experience. As such, the online/in-store analysis system 140 may select an image accordingly, e.g., an image showing the LCD TV in a family oriented setting with adults and children viewing the LCD TV. Also, the online/in-store analysis system 140 may generate a customized product description based on the customer's technical experience, e.g., by describing how the features of the product meet the customer's needs instead of directly enumerating the features. As another example, the online/in-store analysis system 140 may identify that a customer is a young professional with significant technical experience through work experience and interests. In this example, the online/in-store analysis system 140 may select a customized product image that, for example, depicts other individuals of a similar age group and includes a variety of other related A/V technologies or devices. Similarly, the online/in-store analysis system 140 may generate a customized product description that emphasizes technical features of the product.

As mentioned above, the customer output 900 may further include product information indicative of other people's experience with the product or a similar product. In FIG. 9, the customer output 900 includes the social network feedback information 940 and the similar persons feedback information 960, The social network feedback information 940 may indicate one or more of the customer's social network connections who have viewed a particular product. The social network feedback information 940 may further include feedback of the product from the customer's social connections, such as a product review, product rating, suggested related products, or other information indicative of the social connection's experience with the displayed product. Thus, the online/in-store analysis system 140 may present the customer with targeted, filtered feedback information originating from personal or social connections with the customer instead of product feedback originating from the general population as a whole.

In one exemplary implementation, the online/in-store analysis system 140 may access any number or databases, servers, or other information sources to obtain feedback information from the customer's social connections. For example, the online/in-store analysis system 140 may obtain general product feedback data provided by reviewers from a general population segment, e.g., via a store server. The online/in-store analysis system 140 may also access one or more social networks of the customer to identify social connections of the customer. Then, the online/in-store analysis system 140 may filter the general product feedback data according to the customer's social connections to generate the social network feedback information 940.

In one implementation, the online/in-store analysis system 140 may further filter the social network feedback information 940 based on a common interest with respect to the displayed product or a predefined segment of the customer's social connections. For example, for an LCD TV, the online/in-store analysis system 140 may filter the social network feedback information 940 to selectively remove feedback information from any number of the customer's social connections according to a relevant factor criteria, e.g., filtering feedback from a social connection whose technical experience fails to meet a technical experience threshold or criteria. Or, the online/in-store analysis system 140 or a social network may maintain predetermined segments of the customer's social connections (e.g., high school connections, college connections, work connections, connections sharing a common interest, age, demographics, etc.). In this example, the online/in-store analysis system 140 may filter the social network feedback information 940 to include feedback from selected predetermined segments.

The customer output 900 may also display similar product rating, product review, or other product information through the similar persons feedback information 960. For example, the similar persons feedback information 960 may include product feedback information provided by persons meeting a similarity criteria with respect to the customer, including persons outside of the customer's social connections. As another example, the similar persons feedback information 960 may include product feedback data with respect to a predefined customer segment the customer may be included within. The online/in-store analysis system 140 may aggregate such product feedback information from any number of sources, including a store server, databases associated with the server, various social networks, or more. The online/in-store analysis system 140 may categorize the customer into a predetermined customer segment or identify similar persons meeting a similar criteria based on the customer's online data, in-store data, or both.

In one implementation, the online/in-store analysis system 140 may generate the similar persons feedback information 960 by obtaining generalized product feedback (e.g., reviews) from any number of sources, such as a store server. The online/in-store analysis system 140 may also obtain profile data associated with reviewers generating the product feedback. Then, the online/in-store analysis system 140 may add or filter product feedback from the similar persons feedback information 960 by comparing any number of similarity criteria with respect to the reviewer profiles and the customer profile.

The customer output 900 may also display a similar products listing 942, which may display similar products viewed by a social connection of the customer, similar persons with respect to the customer, or both. In this way, the similar products listing 942 may be generated specifically based on previously viewed products of persons within the customer's personal or social network or sharing a predetermined characteristic, e.g., as identified through the similarity criteria. Thus, the similar products listing 942 may provide the customer with a targeted similar products listing instead of a generalized products list generated based on products viewed by the general population.

The customer output 900 shown in FIG. 9 also includes a feedback solicitation option 950. The feedback solicitation option 950 may be implemented as a selectable icon to initiate the solicitation of feedback. The feedback solicitation may present an option for the customer to solicit feedback from any number of the customer's social connections, for example, in real-time while in the store. As discussed above, the online/in-store analysis system 140 may receive a feedback solicitation indication from the customer, such as through the feedback solicitation option 950. In response, the online/in-store analysis system 140 may solicit feedback concerning the displayed product or service directly through a social network, through e-mail, through an online polling website, or any number of other ways. The feedback provided by a customer's social connections may also include a recommendation as to a purchase decision, direct feedback concerning the product or service, or any other feedback information provided by a customer's social connection.

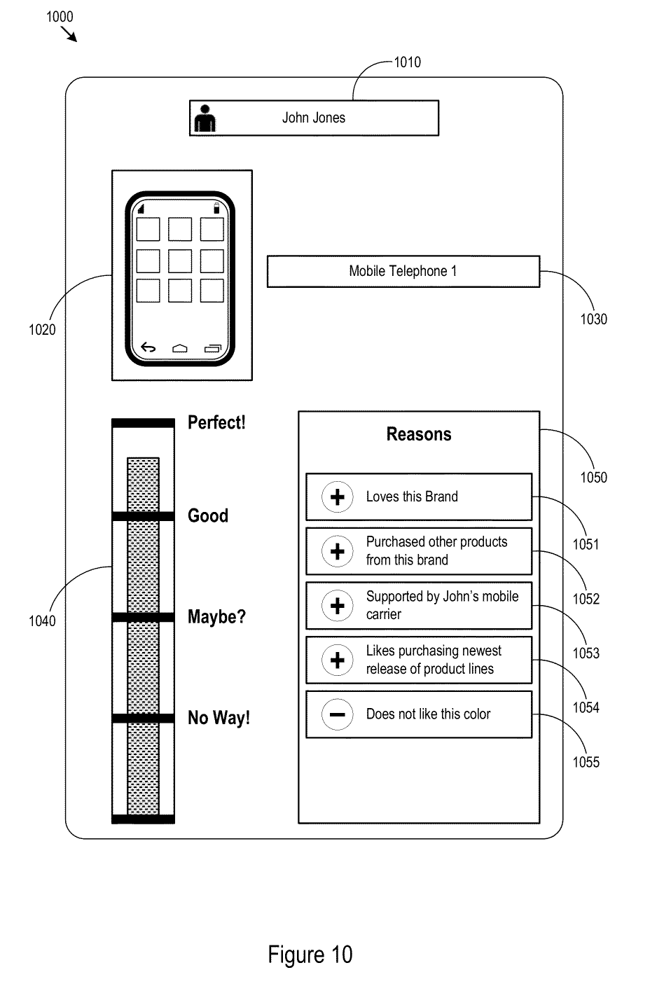

FIG. 10 shows an example of a customer output 1000 with respect to a purchase target other than the customer. The online/in-store analysis system 140 may identify a purchase target when determining purchase intent of a customer. The online/in-store analysis system 140 may obtain a purchase target indication, for example from a customer input. In one implementation, the online/in-store analysis system 140 may prompt a customer as to a purchase target. When the customer indicates a purchase target other than the customer, the online/in-store analysis system 140 may obtain the purchase target indication in various ways. For example, the online/in-store analysis system may present the user with a contact list comprising social connections from any number of social networks of the customer. The online/in-store analysis system 140 may then receive a contact selection from the customer indicating the purchase target.

The online/in-store analysis system 140 generate a customer output, e.g., the customer output 1000 shown in FIG. 10, for a particular product or service. For example, the online/in-store analysis system 140 may generate the customer output 1000 in response to a customer scanning an in-store product, such as a mobile telephone. The generated customer output may include product or service information with respect to the purchase target. In the example shown in FIG. 10, the customer output 1000 includes a purchase target name 1010, a product image 1020, a product name 1030, and product feedback, with respect to the purchase target, such as the recommendation determination 1040 and the recommendation reasoning 1050.

To generate the customer output 1000, the online/in-store analysis system 140 may access online data with respect to the purchase target. For example, the online/in-store analysis system may obtain online information of the purchase target through the customer's connection to a social network, e.g., accessing a social network profile of a customer's social connection via the customer's access to the social network. The online/in-store analysis system 140 may also obtain the purchase target online or in-store data through a store server or online server, e.g., obtaining browsing history, purchase history, or other information related to shopping trends of the purchase target. In one implementation, with online/in-store analysis system 140 may aggregate online or in-store data of the purchase target according to predetermined product segments with respect to the scanned product, e.g., mobile telephones, electronic devices, communication devices, purchases over a certain monetary threshold, or any other segmentation. The online/in-store analysis system 140 may also obtain purchase target data in any of the other information obtaining methods discussed above for the customer.

Upon obtaining the purchase target online and in-store data, the online/in-store analysis system 140 may generate a customer output including a recommendation determination, a recommendation reasoning, or both. The recommendation determination may predict a response of the purchase target with respect to a particular product, e.g., determine a degree which the purchase target may like or enjoy the scanned in-store product. Or the determination recommendation may present a recommendation degree to purchase the product for the purchase target. The online/in-store analysis system 140 may present the recommendation determination in any number of ways. For example, in FIG. 10, the recommendation determination 1040 presents multiple tiers in recommending whether to purchase the particular product for the purchase target, including the recommendation tiers labeled as “Perfect!”, “Good”, “Maybe?”, and “No Way!”. The recommendation determination 1040 may be also be implemented as any known or imagined rating scale, such as numerical scale (e.g., 1 to 5), a star rating, etc.

The online/in-store analysis system 140 may also generate a customer output including a recommendation reasoning, such as the recommendation reasoning 1050. The recommendation reasoning 1050 may indicate relevant information of the purchase target with respect to a particular product, product type, or service. In FIG. 10, the recommendation reasoning 1050 includes the reasons 1051-1055, which include both the positive reasons 1051-1054 and the negative reason 1055. The online/in-store analysis 140 may generate the recommendation reasoning 1050 based on the online and in-store data of the purchase target.

In this way, the online/in-store analysis system 140 may generate a customer output with respect to a purchase target other than the customer. The customer output may include any other information with respect to the purchase target or a product/service that may assist the customer in determining whether to purchase the product or service for the purchase target. As one example, the customer output may include any combination of recommended related products, products the purchase target has indicated an interested in (e.g., a “wish-list” of the purchase target), or other information.

The logic and processing described above may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device. The medium may be implemented as any device or tangible component that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions, or in software in an application programming interface (API) or in a Dynamic Link Library (DLL), functions available in a shared memory or defined as local or remote procedure calls, or as a combination of hardware and software.

The logic and processing described above may include additional or different logic and may be implemented in many different ways. A processor may be implemented as a controller, microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instructions may be parts of a single program, separate programs, implemented in libraries such as Dynamic Link Libraries (DLLs), or distributed across several memories and processors.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

We claim:

1. A system comprising:
a processor;
a memory; and
analysis logic stored on the memory, that, when executed by the processor, is operable to:
receive customer online data;
receive customer in-store data indicative of a customer's in-store activity;
determine a receiving party;
generate an output based on the customer online data, the customer in-store data, and the receiving party; and
transmit the generated output to the receiving party.

2. The system of claim 1, where the customer in-store data comprises position data attributable to the customer, where the position data comprises a walking path of the customer in a store.

3. The system of claim 1, where the customer in-store data comprises scanning data attributable to the customer, where the scanning data comprises data related to an in-store product scanned by the customer.

4. The system of claim 1, where the analysis logic is further operable, in preparation of generating an output, to:
determine the purchase intent of the customer based on the customer in-store data, where the purchase intent is indicative of customer interest in a type of product or service or a brand of product or service.

5. The system of claim 4, where the determination of purchase intent is further based on the customer online data.

6. The system of claim 1, where the analysis logic is further operable, in preparation of generating an output, to:
generate a customer profile based on the customer online data, where the customer profile indicates one or more factors affecting a customer's potential purchase activity.

7. The system of claim 6, where the customer profile comprises any combination of:
an influence attribute, where the influence attribute indicates influence on other people attributable to the customer;
a store online history attribute, where the store online history attribute indicates store activity stored online attributable to the customer;
an affluence attribute, where the affluence attribute indicates potential purchasing ability of the customer;
an interests attribute, where the interests attribute indicates interests and preferences of the customer;
a relationship attribute, where the relationship attribute indicates the effect relationships attributable to the customer has on purchase activity of the customer; and
a background attribute, where the background attributes indicates background information attributable to the customer.

8. The system of claim 1, where determining a receiving party comprises determining whether to send a communication to a customer or to a sales person.

9. The system of claim 8, where, when the determined receiving party is a sales person, the analysis logic is further operable to:
select a particular sales person from a plurality of sales persons.

10. The system of claim 8, where, when the determined receiving party is the sales person, the generated output comprises:
data attributable to a customer; and
one or more suggested store products.

11. The system of claim 1, where the generated output comprises feedback information with respect to an in-store product, the feedback information originating from a social connection of the customer.

12. The system of claim 1, where the generated output comprises feedback information with respect to an in-store product, the feedback information originating from a reviewer meeting a similarity criteria with respect to the customer.

13. The system of claim 1, where the analysis logic is further operable to:
categorize the customer into a customer segment according to the customer online data, customer in-store data, or both;
determine, based on the customer segment, a selected product image, a selected product description, or both; and
where the generated output comprises the selected product image, the selected product description, or both.

14. A method comprising:
receiving customer online data;
receiving customer in-store data indicative of a customer's in-store activity;
determining, using a processor, an output device associated with a receiving party;
generating an output based on the customer online data, the customer in-store data, and the receiving party; and
transmitting the generated output to the determined output device associated with the receiving party.

15. The method of claim 14, where receiving customer in-store data comprises receiving position data attributable to the customer, where the position data comprises a walking path of the customer in a store.

16. The method of claim 14, where receiving customer in-store data comprises receiving scanning data attributable to the customer, where the scanning data comprises data related to an in-store product scanned by the customer.

17. The method of claim 14, further comprising:
determining the purchase intent of the customer based on the customer in-store data, where the purchase intent is indicative of customer interest in a type of product or service or a brand of product or service.

18. The system of claim 14, where determining the purchase intent is further based on the customer online data.

19. The method of claim 14, further comprising:
generating a customer profile based on the customer online data, where the customer profile indicates one or more factors affecting a customer's potential purchase activity.

20. The method of claim 19, where generating the customer profile comprises determining any combination of:
an influence attribute, where the influence attribute indicates influence on other people attributable to the customer;
a store online history attribute, where the store online history attribute indicates store activity stored online attributable to the customer;
an affluence attribute, where the affluence attribute indicates potential purchasing ability of the customer;
an interests attribute, where the interests attribute indicates interests and preferences of the customer;
a relationship attribute, where the relationship attribute indicates the effect relationships attributable to the customer has on purchase activity of the customer;
a background attribute, where the background attributes indicates background information attributable to the customer;
or any combination thereof.

21. The method of claim 14, where determining a receiving party comprises determining whether to send a communication to a customer or to a sales person.

22. The method of claim 21, further comprising, when the determined receiving party is a sales person:
selecting a particular sales person from a plurality of sales persons.

23. The method of claim 21, when the determined receiving party is the sales person, the generated output comprises:
data attributable to a customer; and
one or more suggested store products.

24. The method of claim 14, where generating an output comprises generating feedback information with respect to an in-store product originating from a social connection of the customer.

25. The method of claim 14, where generating an output comprises generating feedback information with respect to an in-store product originating from a person meeting a similarity criteria with respect to the customer.

26. The method of claim 14, further comprising:
categorizing the customer into a customer segment according to the customer online data, customer in-store data, or both;
determining, based on the customer segment, a selected product image, a selected product description, or both; and
where generating an output comprises generating a customized product image with respect to the customer, a customized product description with respect to the customer, or both.

27. A product comprising:
a computer readable medium storing processor executable instructions, that when executed by a processor, cause the processor to: receive customer online data;
receive customer in-store data indicative of a customer's in-store activity;
determine a receiving party;
generate an output based on the customer online data, the customer in-store data, and the receiving party; and
transmit the generated output to the receiving party.

28. The product of claim 27, where the customer in-store data comprises position data attributable to the customer, where the position data comprises a walking path of the customer in a store.

29. The product of claim 27, where the customer in-store data comprises scanning data attributable to the customer, where the scanning data comprises data related to an in-store product scanned by the customer.

30. The product of claim 27, where the processor executable instructions further cause the processor to:
determine the purchase intent of the customer based on the customer in-store data, where the purchase intent is indicative of customer interest in a type of product or service or a brand of product or service.

31. The product of claim 30, where the determination of purchase intent is further based on the customer online data.

32. The product of claim 27, where the processor executable instructions further cause the processor to:
generate a customer profile based on the customer online data, where the customer profile indicates one or more factors affecting a customer's potential purchase activity.

33. The product of claim 32, where the customer profile comprises any combination of:
an influence attribute, where the influence attribute indicates influence on other people attributable to the customer;
a store online history attribute, where the store online history attribute indicates store activity stored online attributable to the customer;
an affluence attribute, where the affluence attribute indicates potential purchasing ability of the customer;
an interests attribute, where the interests attribute indicates interests and preferences of the customer;
a relationship attribute, where the relationship attribute indicates the effect relationships attributable to the customer has on purchase activity of the customer; and
a background attribute, where the background attributes indicates background information attributable to the customer.

34. The product of claim 27, where the processor executable instructions cause the processor to determine a receiving party by determining whether to send a communication to a customer or to a sales person.

35. The product of claim 34, where, when the determined receiving party is a sales person, the processor executable instructions cause the processor to:
select a particular sales person from a plurality of sales persons.

36. The product of claim 34, where, when the determined receiving party is the sales person, the generated output comprises:
data attributable to a customer; and
one or more suggested store products.

37. The product of claim 27, where the generated output comprises feedback information with respect to an in-store product originating from a social connection of the customer.

38. The product of claim 27, where the generated output comprises feedback information with respect to an in-store product originating from a person meeting a similarity criteria with respect to the customer.

39. The product of claim 27, where the processor executable instructions further cause the processor to:
categorize the customer into a customer segment according to the customer online data, customer in-store data, or both;
determine, based on the customer segment, a selected product image, a selected product description, or both; and
where the generated output comprises the selected product image, the selected product description, or both.
